(19) United States
(12) Patent Application Publication
(10) Pub. No.: US 2016/0246481 A1
(43) Pub. Date: Aug. 25, 2016

(54) EXTRACTION OF MULTIPLE ELEMENTS FROM A WEB PAGE

(71) Applicant: eBay Inc., San Jose, CA (US)

(72) Inventors: Priyavrath Dakua, Bangalore (IN); Prajakta Belgundi, Bangalore, IN (US)

(21) Appl. No.: 14/627,889

(22) Filed: Feb. 20, 2015

(51) Int. Cl. G06F 3/0484; G06F 17/30; G06F 17/22; G06F 3/0483; G06F 3/0482

(52) U.S. Cl. CPC G06F 3/04842; G06F 3/0483; G06F 3/0482; G06F 17/2247; G06F 17/30893

(57) ABSTRACT

A tool is provided that allows a user to select a portion of a web page that contains both labels and data values for a set of fields. The tool extracts the labels and the data values. The user can start a data extraction process to query from other pages that are similarly-formatted to the first page and extract data from these other pages. The relationship between the labels and the values can be determined by traversing the domain object model (DOM) of the first page. The tool may be integrated into a custom web browser that includes a user interface (UI) element that can be switched on and off. When the UI element is off, selection of text operates as in a normal web browser. When the UI element is switched on, selection of text operates as described above to facilitate the extraction of data.

### TECHNICAL FIELD

The subject matter disclosed herein generally relates to user interfaces (UIs) for extraction of data from dynamically-generated web pages. Specifically, the present disclosure addresses systems and methods related to an improved UI that reduces the user effort required to initiate the extraction of data.

### BACKGROUND

Tools exist to help users query and extract data from web pages generated dynamically from databases. The data may be stored in a user database to allow the user to process the data as desired, rather than through the web interface. Tools typically require the user to identify the fields of data of interest individually and to provide names for the fields.

### BRIEF DESCRIPTION OF THE DRAWINGS

Some embodiments are illustrated, by way of example and not limitation, in the figures of the accompanying drawings.

FIG. 1 is a network diagram illustrating a network environment suitable for extraction of data from web pages, according to some example embodiments.

FIG. 2 is a block diagram illustrating components of a web server suitable for hosting data to be extracted, according to some example embodiments.

FIG. 3 is a block diagram illustrating components of a device suitable for extracting data from web pages, according to some example embodiments.

FIG. 4 is a UI diagram illustrating a UI suitable for extracting multiple fields of data from web pages, according to some example embodiments.

FIG. 5 is a UI diagram illustrating a UI suitable for extracting multiple fields of data from web pages, according to some example embodiments.

FIG. 6 is a UI diagram illustrating a UI suitable for extracting multiple fields of data from web pages, according to some example embodiments.

FIG. 7 is a UI diagram illustrating a UI suitable for extracting multiple fields of data from web pages, according to some example embodiments.

FIG. 8 is a flowchart illustrating operations of a device in extracting multiple fields of data from web pages, according to some example embodiments.

FIG. 9 is a block diagram illustrating an example of a software architecture that may be installed on a machine, according to some example embodiments.

FIG. 10 illustrates a diagrammatic representation of a machine in the form of a computer system within which a set of instructions may be executed for causing the machine to perform any one or more of the methodologies discussed herein, according to an example embodiment.

### DETAILED DESCRIPTION

Example methods and systems are directed to tools that aid in data extraction from web pages. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A tool is provided that allows a user to select a portion of a web page that contains both labels and data values for a set of fields. After the portion is selected, the tool extracts the labels and the data values and prompts the user to confirm or modify the extracted values. For example, a label used on the web page can be changed to a label more to the liking of the user. As another example, a label/value pair that is not of interest to the user can be deleted. Once the user is satisfied with the labels and extracted data, the user can start a data extraction process to query and extract data. The extracted data is used to populate a database or generate a comma-separated-value (CSV) file.

In some example embodiments, the relationships between the labels and the values are determined by traversing the domain object model (DOM) of the web page. For example, the labels may be stored in one column of a table and the values in another column. Thus, the labels and the values may each be leaf nodes in the DOM. Corresponding labels and values may have a common parent representing the row in the DOM. Accordingly, identification of the selected leaf nodes serves to identify the relationships between those nodes as well, allowing each label and key to be paired. Other relationships between labels and values can also be used. For example, one list may contain the values while another list contains the labels. Thus, a label leaf may have a list parent which is a child of a body of the page. The corresponding value leaf has a separate list parent which is another child of the body of the page. An index of the label leaf in its list may match an index of the value leaf in its list. Accordingly, the relationship between the value and the label can be identified by virtue of a shared grandparent object (e.g., the body of the page) and a matching index within their respective lists.

The tool may be integrated into a custom web browser that includes a UI element that can be switched on and off. When the UI element is off, selection of text operates as in a normal web browser. When the UI element is switched on, selection of text operates as described above to facilitate the extraction of data.

The gathering of labels and data from the selected text may be triggered in a number of ways. For example, another UI element in the custom web browser (e.g., a button) may be used as a trigger. As another example, a mouse button right-click may be used as a trigger.

Either before or after the labels and values are extracted by the tool, the labels, values, or both may be highlighted on a screen for the user. For example, a color of the text may be changed, a background color behind the text may be changed, a box may be drawn around the text, or any suitable combination thereof. When a label is deleted by the user, the corresponding highlighting may be removed.

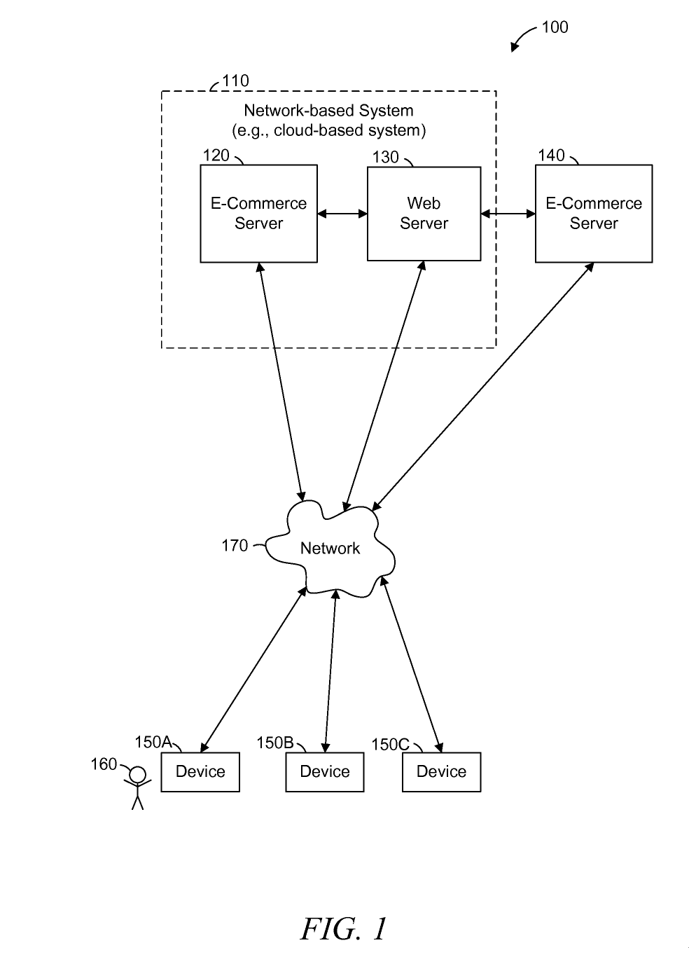

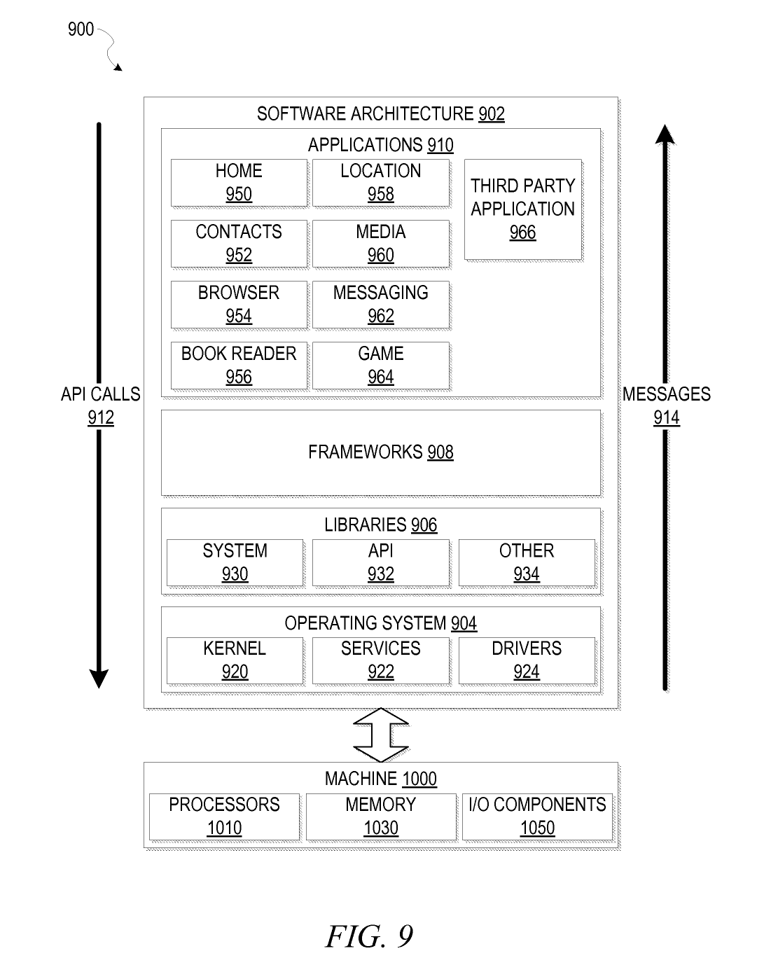

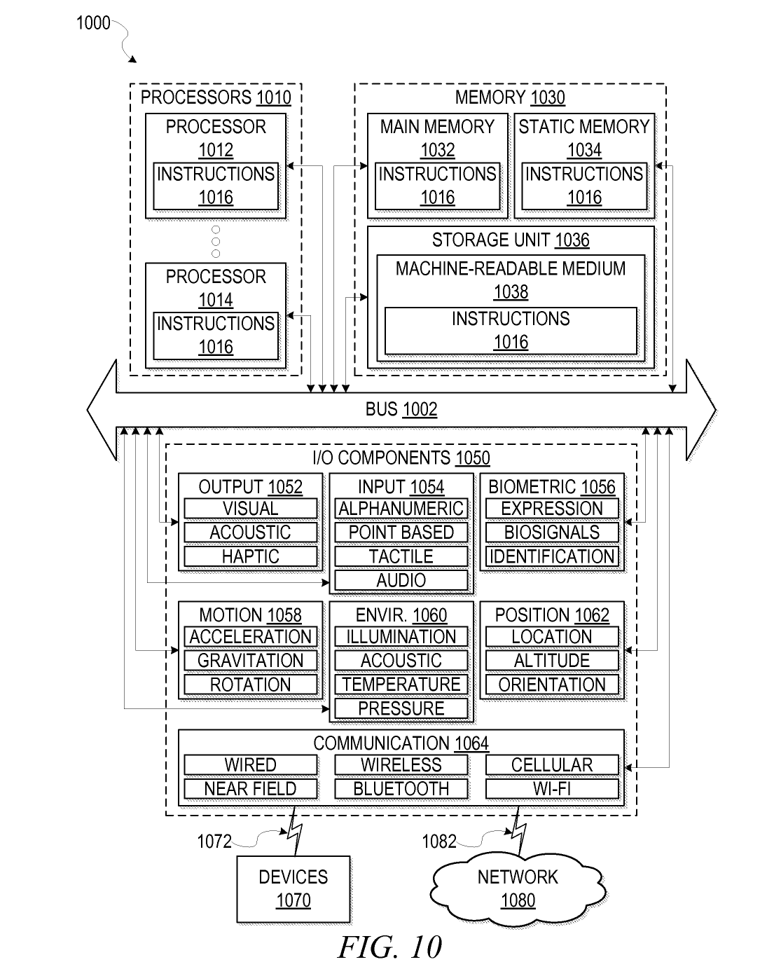

FIG. 1 is a network diagram illustrating a network environment 100 suitable for extraction of data from web pages, according to some example embodiments. The network environment 100 includes e-commerce servers 120 and 140, a web server 130, and devices 150A, 150B, and 150C, all communicatively coupled to each other via a network 170. The devices 150A, 150B, and 150C may be collectively referred to as “devices 150,” or generically referred to as a “device 150.” The e-commerce servers 120 and 140 and the web server 130 may be part of a network-based system 110. Alternatively, the devices 150 may couple to the web server 130 directly or over a local network distinct from the network 170 used to couple to the e-commerce server 120 or 140. The e-commerce servers 120 and 140, the web server 130, and the devices 150 may each be implemented in a computer system, in whole or in part, as described below with respect to FIGS. 9-10.

The e-commerce servers 120 and 140 provide an electronic commerce application to other machines (e.g., the devices 150) via the network 170. The e-commerce servers 120 and 140 may also be connected directly to, or integrated with, the web server 130. In some example embodiments, one e-commerce server 120 and the web server 130 are part of a network-based system 110, while other e-commerce servers (e.g., the e-commerce server 140) are separate from the network-based system 110. The electronic commerce application may provide a way for users to buy and sell items directly to each other, to buy from and sell to the electronic commerce application provider, or both.

The web server 130 serves web pages containing data. The web pages have similar formatting but include data for different items. For example, the web server 130 may have access to a database storing name, description, year of manufacture, price, and so on for a set of products, services, people, or any suitable combination thereof. By accessing the database, web pages can be statically or dynamically generated and served by the web server 130. The web server 130 may provide data to other machines (e.g., the e-commerce servers 120 and 140 or the devices 150) via the network 170 or another network. The web server 130 may receive data from other machines (e.g., the e-commerce servers 120 and 140 or the devices 150) via the network 170 or another network. In some example embodiments, the functions of the web server 130 described herein are performed on a user device, such as a personal computer (PC), tablet computer, or smart phone. For example, an application may provide a web interface to access proprietary data stored in an encrypted database and not otherwise accessible by the user.

Also shown in FIG. 1 is a user 160. The user 160 may be a human user, a machine user (e.g., a computer configured by a software program to interact with the devices 150 and the web server 130), or any suitable combination thereof (e.g., a human assisted by a machine or a machine supervised by a human). The user 160 is not part of the network environment 100, but is associated with the devices 150 and may be a user of the devices 150. For example, the device 150 may be a sensor, a desktop computer, a vehicle computer, a tablet computer, a navigational device, a portable media device, or a smart phone belonging to the user 160. In some example embodiments, the device 150 gathers data from the web server 130 and stores it in a local or networked database, for later access by the user 160, the e-commerce server 120 or 140, or another user or machine.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 9-10. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 170 may be any network that enables communication between or among machines, databases, and devices (e.g., the web server 130 and the devices 150). Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

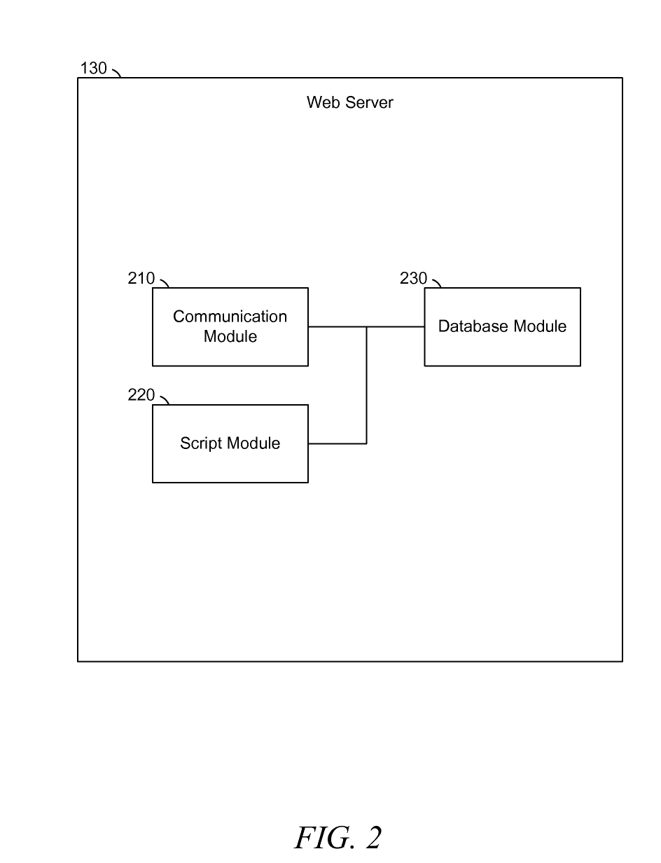

FIG. 2 is a block diagram illustrating components of the web server 130, according to some example embodiments. The web server 130 is shown as including a communication module 210, a script module 220, and a database module 230 all configured to communicate with each other (e.g., via a bus, shared memory, or a switch). Any one or more of the modules described herein may be implemented using hardware (e.g., a processor of a machine). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 is configured to send and receive data. For example, the communication module 210 may receive Hypertext Transport Protocol (HTTP) requests for HyperText Markup Language (HTML) pages over the network 170 and send the received data to the script module 220. As another example, the script module 220 may dynamically generate a web page to be transmitted by the communication module 210 over the network 170 to the device 150.

The script module 220 is configured to dynamically generate web pages using data accessed through the database module 230 in response to requests received by the communication module 210. The script module 220 may have a template into which the data is populated, providing a standard form for presentation of the data.

The database module 230 is configured to store and retrieve data used by the script module 220. For example, tables of data regarding items, products, web pages, users, or any suitable combination thereof may be stored by the database module 230 and accessed and caused to be presented by the script module 220.

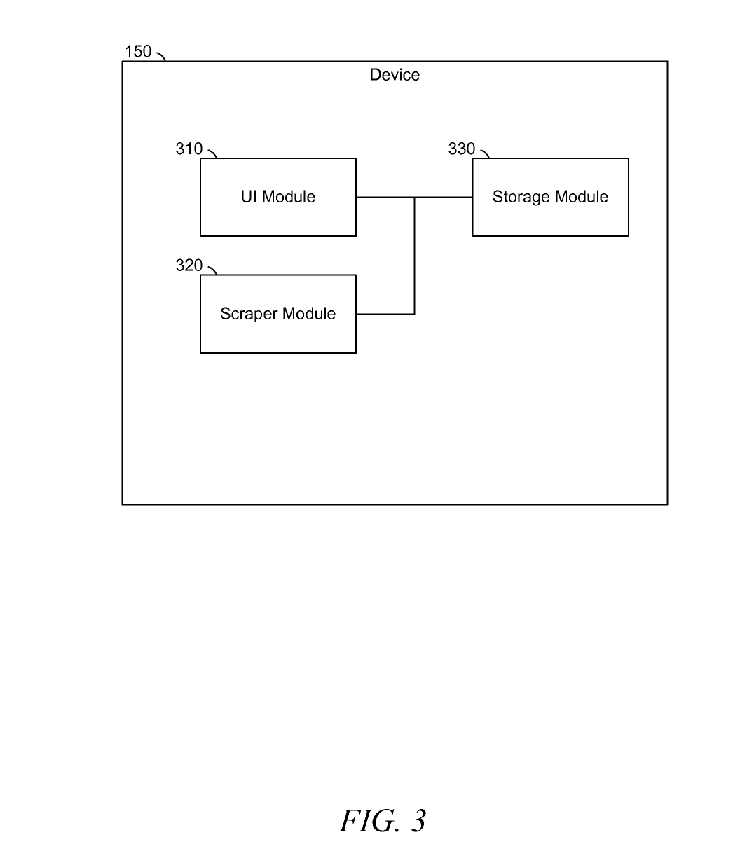

FIG. 3 is a block diagram illustrating components of the device 150, according to some example embodiments. The device 150 is shown as including a UI module 310, a scraper module 320, and a storage module 330, all configured to communicate with each other (e.g., via a bus, shared memory, or a switch). Any one or more of the modules described herein may be implemented using hardware (e.g., a processor of a machine). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The UI module 310 is configured to receive input from a user via a user interface. For example, the user may enter an initial uniform resource locator (URL) to be used as a template for data gathering, select a set of fields containing data to be gathered, and submit a request for the data gathering to begin.

The scraper module 320 is configured to retrieve (or scrape) data from a target web server. For example, configuration options provided by the UI module 310 can be used to control the retrieval and parsing of data. The retrieved data may be stored by the storage module 330 for later access by the user.

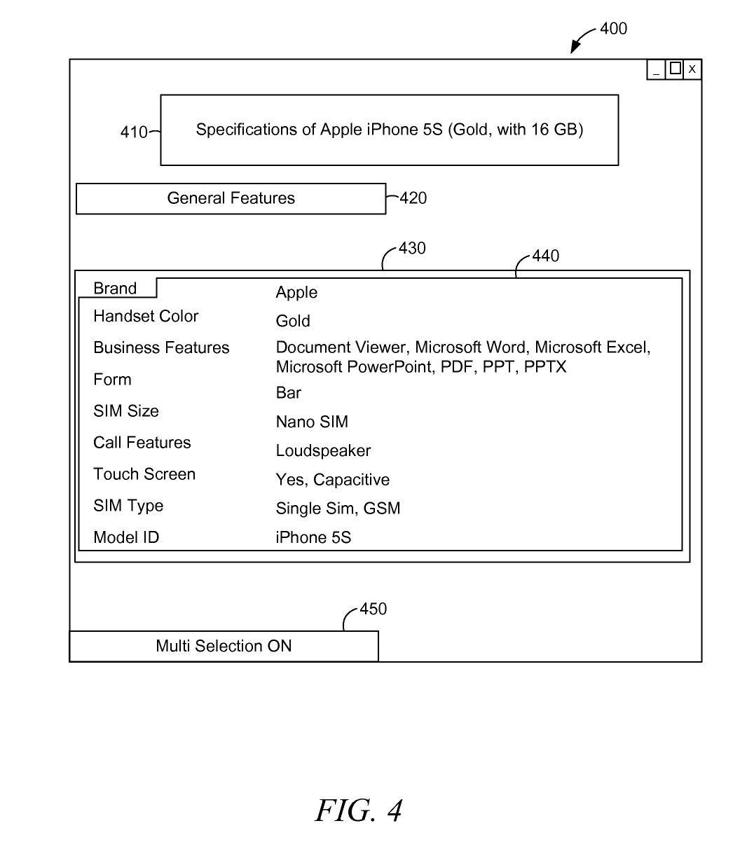

FIG. 4 is a UI diagram illustrating a UI 400 suitable for extracting multiple fields of data from web pages, according to some example embodiments. The UI 400 includes an item title 410, a heading 420, data 430, a selection 440, and a multi selection indicator 450.

The item title 410 indicates that the current item being viewed is an Apple iPhone 5S. The heading 420 indicates that “general features” for the current item are shown in the data 430. The data 430 shows, for example, a brand, handset color, list of business features, form, subscriber identification module (SIM) size, call features, touch screen, SIM type, and model identifier (ID) of the item. The selection 440 indicates that the user of the UI 400 has highlighted a portion of the UI 400 within the selection 440. For example, using a mouse, the user may have depressed the mouse button while the cursor was positioned to the right of “Brand” and then dragged the cursor to the right of “iPhone 5S,” followed by releasing the mouse button. The indicator 450 shows that multi selection is enabled. In some example embodiments, multi selection must be enabled prior to the selection of the set of values or keys of interest to the user. The indicator 450 may be operable to toggle the enablement of multi selection.

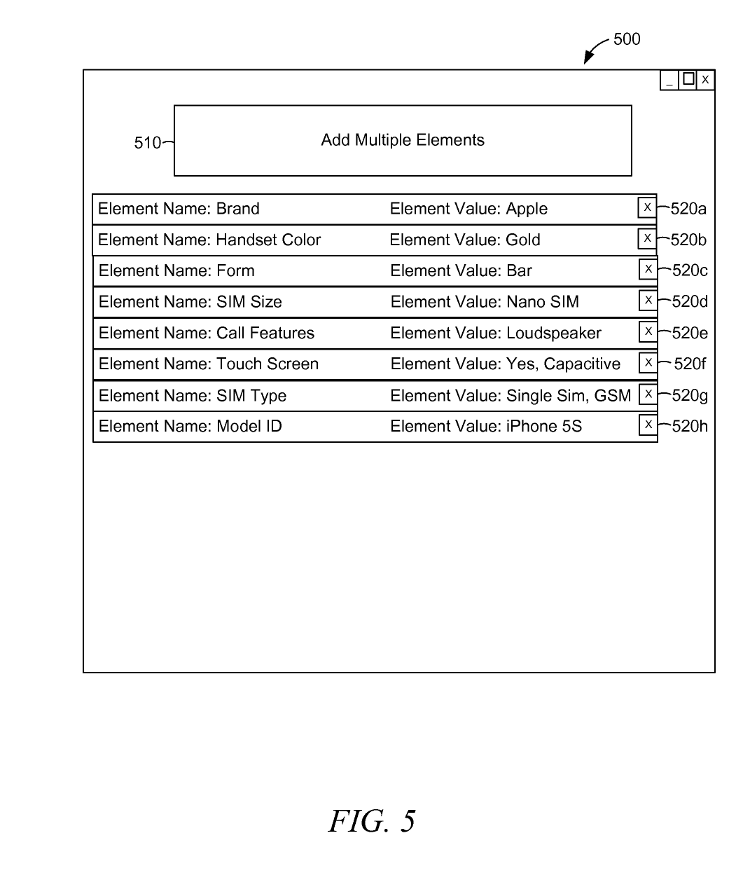

FIG. 5 is a UI diagram illustrating a UI 500 suitable for extracting multiple fields of data from web pages, according to some example embodiments. The UI 500 includes a title 510 and a list 520 (comprising individual elements 520a-520h) of element names and values. The UI 500 may be displayed in response to a user action indicating that the selection made on the UI 400 is to be used for multiple element data extraction. Each of the elements 520a-520h corresponds to one element name/value pair in the data 430. Each element 520a-520h shows both the element name and the element value for the pair. For example, element 520a shows the element name as “Brand” and the element value as “Apple.” In some example the embodiments, the UI 500 allows the user to edit the element names, element values, or both. For example, the user can select the word “Brand” and replace it with “Make.” The elements 520a-520h may each include a UI element (shown in FIG. 5 as a box containing an “x”) operable to remove the corresponding element 520a-520h from the list 520.

In some example embodiments, the UI 500 is shown simultaneously with the UI 400. For example, the UI 500 may be shown in a pop-up window while the UI 400 continues to be displayed. The UI 500 may contain additional UI elements operable to accept the list of elements, undo changes made to the list of elements, abandon the multi selection process, or any suitable combination thereof.

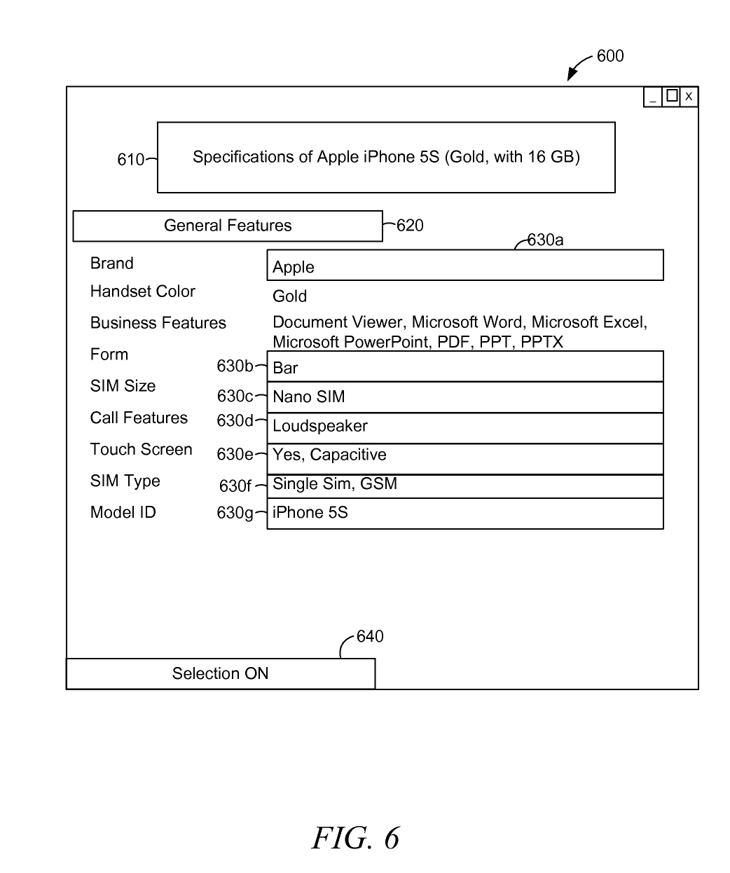

FIG. 6 is a UI diagram illustrating a UI 600 suitable for extracting multiple fields of data from web pages, according to some example embodiments. The UI 600 includes an item title 610, a heading 620, highlights 630a-630g, and a selection indicator 640. The UI 600 may correspond to the UI 400 after a set of elements have been selected using the UI 500. The highlights 630a-630g indicate which values are being extracted from the page being shown. Accordingly, since the “Handset Color” value is not highlighted, this reflects a choice on the UI 500 to exclude that element from extraction. The highlights 630a-630g may be hidden or shown by the use of the selection indicator 640.

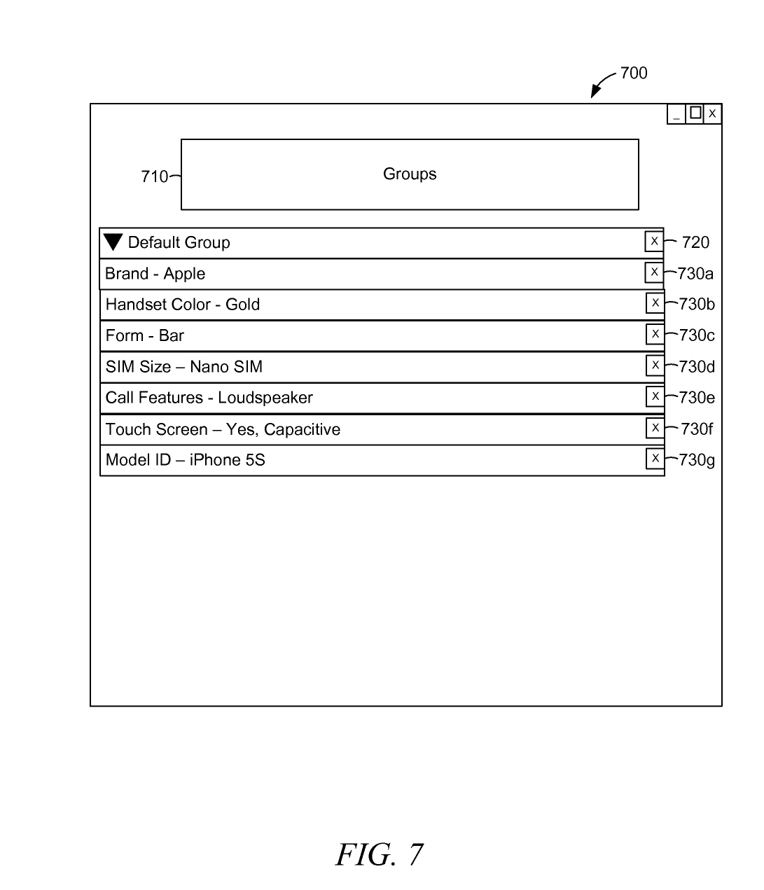

FIG. 7 is a UI diagram illustrating a UI 700 suitable for extracting multiple fields of data from web pages, according to some example embodiments. The UI 700 includes a page title 710, a group label 720, and a list of keys and values 730 (containing elements 730a-730g). The UI 700 may be displayed alongside the UI 600, which may be dynamically updated in response to selections and deletions made in the UI 700. For example, by selecting the “x” for element 730g, the element “Model ID” may be removed. In response, the highlight 630g surrounding “iPhone 5S” on the UI 600 may be removed, to retain the correspondence between the highlighting and the data items to be extracted.

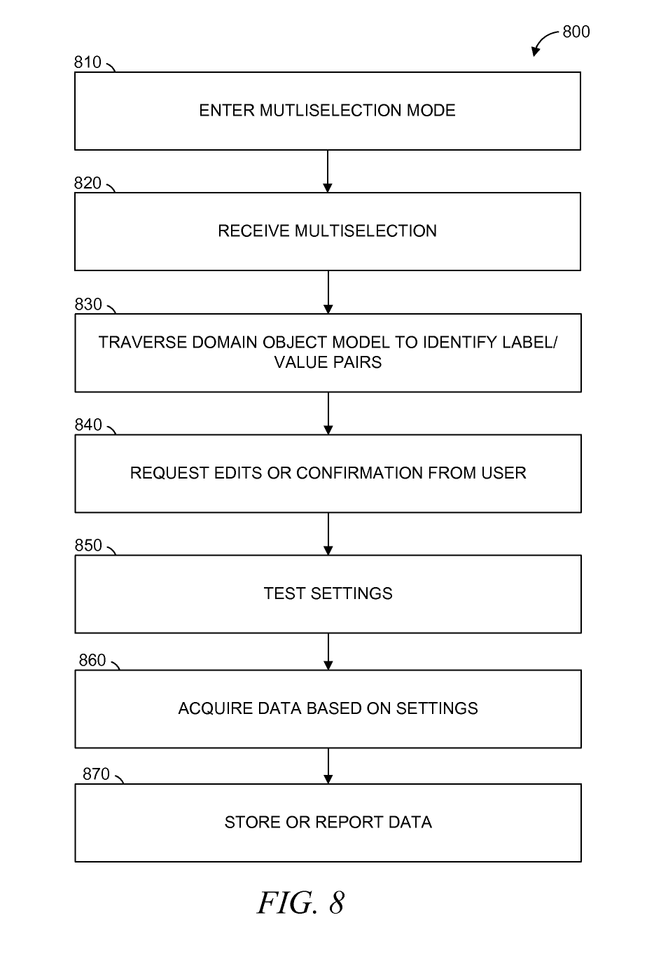

FIG. 8 is a flowchart illustrating operations of a device performing a process 800 in extracting multiple fields of data from web pages, according to some example embodiments. The process 800 includes operations 810, 820, 830, 840, 850, 860, and 870. By way of example and not limitation, the operations 810-870 are described as being performed by the modules 210-230 and 310-330.

In operation 810, the UI module 310 enters multi selection mode. For example, the multi selection indicator 450 may be used to turn on multi selection mode or multi selection mode may be on by default. The UI module 310 receives a multi selection in operation 820. For example, the selection 440, including multiple values, may be received.

In operation 830, the UI module 310 traverses the DOM to identify label/value pairs. As an example, the pseudo-code below may be used. In the example below, elements having the “hidden” attribute are detected and not added to the list of values to be extracted. In some example embodiments, elements having the hidden attribute are added to the list of values, but flagged as hidden. The hidden elements are then extracted, ignored, or removed from the list of values automatically, based on a system setting, based on a user setting, or any suitable combination thereof.

```
function getSelectedElementTags( ) {
............
// Check if mouse drag covers a range of elements
sel = window.getSelection( );
  if (sel.rangeCount > 0) {
    range = sel.getRangeAt(0);
  }
.............
if (range) {
    containerElement = range.commonAncestorContainer;
    if (containerElement.nodeType != 1) {
      containerElement = containerElement.parentNode;
    }
// traverse the DOM to get the elements that appear in the range.
    treeWalker = window.document.createTreeWalker(
      containerElement,
      NodeFilter.SHOW_ELEMENT,
      function(node) {
        return rangeIntersectsNode(range, node) ?
NodeFilter.FILTER_ACCEPT : NodeFilter.FILTER_REJECT; },
      false
    );
..............
// detect if an element is hidden. Use to avoid adding hidden elements
to the data extraction.
function isHiddenElement(element) {
  var display = Element.getAttribute(“display”);
  if (display === “none”) {
    return true}
  else {
    return false}
}
// Get the element expressions that are selected as part of mouse drag
and right click.
var map = new Object( );
  while (treeWalker.nextNode( )) {
      var presentElement = treeWalker.currentNode;
      if(presentElement.nodeType === Node.ELEMENT_NODE &&
presentElement.childNodes.length===1 && !isHidden(presentElement)){
        //alert(‘NODE : ‘+presentElement.nodeName+’ current Node
        Text:
‘+presentElement.innerHTML +’ first child :
‘+presentElement.firstChild.nodeType+’ Name
:‘+presentElement.firstChild.nodeName );
        //push only if it is leaf node - to be recalculated for div, span
        var retValue = getElementExpression(presentElement);
        var cssData = retValue.split(‘~’);
        var checkString = cssData[3];
        if(checkString && checkString.length>0 &&
        !map[checkString]) {
          map[checkString] = checkString;
          //check if it is the following TD in case of table elements
          if(retValue.length>1 && isAdjacentTD(retValue)){
            elmlist = elmlist+‘~~~~’+retValue;
          }
      }
  }
}
```

In operation 840, the UI module 310 requests edits or confirmation from the user. For example, the UI 500 may be presented, allowing the user to modify or remove values to be extracted. In some example embodiments, the UI module 310 may be configured to receive additional selections of areas on the screen. Each additional selection is parsed to identify elements, eliminate duplicate elements, and add new elements to the key-value list of the UI 500. For example, if the user selects a first region to add and then a second, overlapping, region to add, the duplicate elements in the second region are detected and not added to the list of values to be extracted a second time.

In operation 850, the settings are tested by the scraper module 320. For example, the user may select a single web page (e.g., by entering a URL) that is expected to contain extractable data that may be loaded and presented by the UI module 310, with the data to be extracted indicated using highlighting, such as that shown in FIG. 6. The user may further modify the data-gathering settings or approve them.

The scraper module 320 loads additional web pages from the web server 130, parses the DOM of each web page, and extracts the selected data fields (operation 860). The extracted data is stored (e.g., via the storage module 330) or reported (e.g., by addition to a server-side storage solution, by creation of a CSV file, or any suitable combination thereof). The additional pages loaded by the scraper module 320 may be selected by an in-depth crawl of the site (e.g., by recursively following links included in web pages of the site). Additionally or alternatively, the additional pages may be identified by a user selection of one or more pagination links, one or more links on search pages, or any suitable combination thereof. The user selection of links may be used to configure the in-depth web crawler. For example, if the user selects the pagination results for a sample search, the in-depth web crawler can select the pagination results for automatically-generated searches to identify the additional web pages.

In some example embodiments, a table is created in a database for each scraping job. The name of the table is based on the scraping job. For example, the name of the table may be the user name concatenated with a date/time stamp indicating the time at which the scraping job was created or begun. The table includes a column for each key, with the key name used as the name of the column. Each row of the table corresponds to one page from which data was scraped and may include an entry containing the date/time at which the data was scraped, an entry containing the URL from which the data was scraped, or any suitable combination thereof.

According to various example embodiments, one or more of the methodologies described herein may facilitate extracting data from a set of web pages. When these effects are considered in aggregate, one or more of the methodologies described herein may obviate a need for certain efforts or resources that otherwise would be involved in extracting data from a set of web pages. Efforts expended by a user in extracting data from a set of web pages may also be reduced by one or more of the methodologies described herein. For example, the multi selection methods described herein may reduce the amount of time or effort expended by the user in acquiring data. Computing resources used by one or more machines, databases, or devices (e.g., within the network environment 100) may similarly be reduced. Examples of such computing resources include processor cycles, network traffic, memory usage, data storage capacity, power consumption, and cooling capacity.

### Software Architecture

FIG. 9 is a block diagram 900 illustrating an architecture of software 902, which may be installed on any one or more of the devices described above. FIG. 9 is merely a non-limiting example of a software architecture, and it will be appreciated that many other architectures may be implemented to facilitate the functionality described herein. The software 902 may be implemented by hardware such as machine 1000 of FIG. 10 that includes processors 1010, memory 1030, and I/O components 1050. In this example architecture, the software 902 may be conceptualized as a stack of layers where each layer may provide a particular functionality. For example, the software 902 includes layers such as an operating system 904, libraries 906, frameworks 908, and applications 910. Operationally, the applications 910 invoke application programming interface (API) calls 912 through the software stack and receive messages 914 in response to the API calls 912, according to some implementations.

In various implementations, the operating system 904 manages hardware resources and provides common services. The operating system 904 includes, for example, a kernel 920, services 922, and drivers 924. The kernel 920 acts as an abstraction layer between the hardware and the other software layers in some implementations. For example, the kernel 920 provides memory management, processor management (e.g., scheduling), component management, networking, security settings, among other functionality. The services 922 may provide other common services for the other software layers. The drivers 924 may be responsible for controlling or interfacing with the underlying hardware. For instance, the drivers 924 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 906 provide a low-level common infrastructure that may be utilized by the applications 910. The libraries 906 may include system libraries 930 (e.g., C standard library) that may provide functions such as memory allocation functions, string manipulation functions, mathematic functions, and the like. In addition, the libraries 906 may include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 906 may also include a wide variety of other libraries 934 to provide many other APIs to the applications 910.

The frameworks 908 provide a high-level common infrastructure that may be utilized by the applications 910, according to some implementations. For example, the frameworks 908 provide various graphic user interface (GUI) functions, high-level resource management, high-level location services, and so forth. The frameworks 908 may provide a broad spectrum of other APIs that may be utilized by the applications 910, some of which may be specific to a particular operating system or platform.

In an example embodiment, the applications 910 include a home application 950, a contacts application 952, a browser application 954, a book reader application 956, a location application 958, a media application 960, a messaging application 962, a game application 964, and a broad assortment of other applications such as third party application 966. According to some embodiments, the applications 910 are programs that execute functions defined in the programs. Various programming languages may be employed to create one or more of the applications 910, structured in a variety of manners, such as object-orientated programming languages (e.g., Objective-C, Java, or C++) or procedural programming languages (e.g., C or assembly language). In a specific example, the third party application 966 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 966 may invoke the API calls 912 provided by the mobile operating system 904 to facilitate functionality described herein.

### Example Machine Architecture and Machine-Readable Medium

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and input/output (I/O) components 1050, which may be configured to communicate with each other via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1012 and processor 1014 that may execute instructions 1016. The term “processor” is intended to include multi-core processors that may comprise two or more independent processors (also referred to as “cores”) that may execute instructions contemporaneously. Although FIG. 10 shows multiple processors, the machine 1000 may include a single processor with a single core, a single processor with multiple cores (e.g., a multi-core process), multiple processors with a single core, multiple processors with multiples cores, or any combination thereof.

The memory 1030 may include a main memory 1032, a static memory 1034, and a storage unit 1036 accessible to the processors 1010 via the bus 1002. The storage unit 1036 may include a machine-readable medium 1038 on which is stored the instructions 1016 embodying any one or more of the methodologies or functions described herein. The instructions 1016 may also reside, completely or at least partially, within the main memory 1032, within the static memory 1034, within at least one of the processors 1010 (e.g., within the processor's cache memory), or any suitable combination thereof, during execution thereof by the machine 1000. Accordingly, in various implementations, the main memory 1032, static memory 1034, and the processors 1010 are considered as machine-readable media 1038.

As used herein, the term “memory” refers to a machine-readable medium 1038 able to store data temporarily or permanently and may be taken to include, but not be limited to, random-access memory (RAM), read-only memory (ROM), buffer memory, flash memory, and cache memory. While the machine-readable medium 1038 is shown in an example embodiment to be a single medium, the term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 1050 include a wide variety of components to receive input, provide output, produce output, transmit information, exchange information, capture measurements, and so on. In general, it will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 include output components 1052 and input components 1054. The output components 1052 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1054 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In some further example embodiments, the I/O components 1050 include biometric components 1056, motion components 1058, environmental components 1060, or position components 1062 among a wide array of other components. For example, the biometric components 1056 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 include acceleration sensor components (e.g., accelerometer), gravitation sensor components, rotation sensor components (e.g., gyroscope), and so forth. The environmental components 1060 include, for example, illumination sensor components (e.g., photometer), acoustic sensor components (e.g., one or more microphones that detect background noise), temperature sensor components (e.g., one or more thermometer that detect ambient temperature), pressure sensor components (e.g., barometer), humidity sensor components, proximity sensor components (e.g., infrared sensors that detect nearby objects), gas sensors (e.g., machine olfaction detection sensors, gas detection sensors to detection concentrations of hazardous gases for safety or to measure pollutants in the atmosphere), or other components that may provide indications, measurements, or signals corresponding to a surrounding physical environment. The position components 1062 include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072, respectively. For example, the communication components 1064 include a network interface component or another suitable device to interface with the network 1080. In further examples, communication components 1064 include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, in some implementations, the communication components 1064 detect identifiers or include components operable to detect identifiers. For example, the communication components 1064 include Radio Frequency Identification (RFID) tag reader components, NFC smart tag detection components, optical reader components (e.g., an optical sensor to detect a one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, Uniform Commercial Code Reduced Space Symbology (UCC RSS)-2D bar code, and other optical codes), acoustic detection components (e.g., microphones to identify tagged audio signals), or any suitable combination thereof. In addition, a variety of information can be derived via the communication components 1064, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or other type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

In example embodiments, the instructions 1016 are transmitted or received over the network 1080 using a transmission medium via a network interface device (e.g., a network interface component included in the communication components 1064) and utilizing any one of a number of well-known transfer protocols (e.g., HTTP). Similarly, in other example embodiments, the instructions 1016 are transmitted or received using a transmission medium via the coupling 1072 (e.g., a peer-to-peer coupling) to devices 1070. The term “transmission medium” shall be taken to include any intangible medium that is capable of storing, encoding, or carrying instructions 1016 for execution by the machine 1000, and includes digital or analog communications signals or other intangible medium to facilitate communication of such software.

Furthermore, the machine-readable medium 1038 is non-transitory (in other words, not having any transitory signals) in that it does not embody a propagating signal. However, labeling the machine-readable medium 1038 as “non-transitory” should not be construed to mean that the medium is incapable of movement; the medium should be considered as being transportable from one physical location to another. Additionally, since the machine-readable medium 1038 is tangible, the medium may be considered to be a machine-readable device.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a user interface module configured to:
present a web page;
receive a selection of multiple elements on the web page; and
identify a set of one or more key-value pairs from the selection, based on a domain object model (DOM) of the web page; and
a scraper module configured to:
access a set of one or more additional web pages, each additional web page having similar formatting to the web page presented by the user interface module; and
for each web page in the set of additional web pages, extract values corresponding to the identified set of key-value pairs, based on a DOM of each web page.

2. The system of claim 1, wherein the user interface module is further configured to:
present the set of key-value pairs along with user interface elements operable to delete each key-value pair from the set;
detect an operation of one or more of the user interface elements; and
responsive to each detection, delete the corresponding key-value pair from the set of key-value pairs, wherein the deletion occurs prior to the accessing of the additional web pages by the scraper module.

3. The system of claim 1, further comprising a storage module configured to:
store the values extracted by the scraper module.

4. The system of claim 3, wherein the values are stored in a relational database using column names matching keys of the key-value pairs.

5. The system of claim 1, wherein the identification of the set of key-value pairs includes detecting a duplicate key-value pair and removing the duplicate from the set.

6. The system of claim 1, wherein the user interface module is further configured to:
display a further web page, the further web page modified by the user interface module to highlight values corresponding to the set of key-value pairs.

7. The system of claim 6, wherein the user interface module is further configured to:
display a control operable to hide the highlighting;
detect an operation of the control; and
responsive to the operation, cease the highlighting of the values.

8. The system of claim 1, wherein the receipt of the selection of the multiple elements on the web page comprises:
receiving a selection of an area on the web page;
identifying a set of elements within the area, based on the DOM of the web page;
removing an element from the set of elements, based on the element having a hidden attribute; and
identifying the multiple elements on the web page from the remaining elements of the set of elements.

9. A method comprising:
presenting a web page on a display device;
receiving a selection of multiple elements on the web page;
identifying, by a processor of a machine, a set of one or more key-value pairs from the selection, based on a domain object model (DOM) of the web page;
accessing a set of one or more additional web pages, each additional web page having similar formatting to the web page presented on the display device; and
for each web page in the set of additional web pages, extracting values corresponding to the identified set of key-value pairs, based on a DOM of each web page.

10. The method of claim 9, further comprising:
presenting the set of key-value pairs along with user interface elements operable to delete each key-value pair from the set;
detecting an operation of one or more of the user interface elements; and
responsive to each detection, deleting the corresponding key-value pair from the set of key-value pairs, wherein the deletion occurs prior to the accessing of the additional web pages.

11. The method of claim 9, further comprising:
storing the extracted values.

12. The method of claim 11, wherein the values are stored in a relational database using column names matching keys of the key-value pairs.

13. The method of claim 9, wherein the identifying of the set of key-value pairs includes detecting a duplicate key-value pair and removing the duplicate from the set.

14. The method of claim 9, further comprising:
displaying a further web page, the further web page modified by a processor to highlight values corresponding to the set of key-value pairs.

15. The method of claim 14, further comprising:
displaying a control operable to hide the highlighting;
detecting an operation of the control; and
responsive to the operation, ceasing the highlighting of the values.

16. The method of claim 9, wherein the receiving of the selection of the multiple elements on the web page comprises:
receiving a selection of an area on the web page;
identifying a set of elements within the area, based on the DOM of the web page;
removing an element from the set of elements, based on the element having a hidden attribute; and
identifying the multiple elements on the web page from the remaining elements of the set of elements.

17. A machine-readable medium having instructions embodied thereon, which, when executed by one or more processors of one or more machines, cause the machines to perform operations comprising:
presenting a web page on a display device;
receiving a selection of multiple elements on the web page;
identifying a set of one or more key-value pairs from the selection, based on a domain object model (DOM) of the web page;
accessing a set of one or more additional web pages, each additional web page having similar formatting to the web page presented on the display device; and
for each web page in the set of additional web pages, extracting values corresponding to the identified set of key-value pairs, based on a DOM of each web page.

18. The machine-readable medium of claim 17, wherein the operations further comprise:
presenting the set of key-value pairs along with user interface elements operable to delete each key-value pair from the set;
detecting an operation of one or more of the user interface elements; and
responsive to each detection, deleting the corresponding key-value pair from the set of key-value pairs, wherein the deletion occurs prior to the accessing of the additional web pages.

19. The machine-readable medium of claim 17, wherein the operations further comprise:
storing the extracted values.

20. The machine-readable medium of claim 19, wherein the values are stored in a relational database using column names matching keys of the key-value pairs.
